(19) United States
(12) Patent Application Publication
(10) Pub. No.: US 2008/0022572 A1
(43) Pub. Date: Jan. 31, 2008

(54) Back signs for roads

(76) Inventors: Harry Andrew Beale, Charlotte, NC (US); Sonia Leigh Berry, Charlotte, NC (US); James Malcolm Seth Beale, San Francisco, CA (US)

Correspondence Address: HAMMER & HANF, PC, 3125 SPRINGBANK LANE, SUITE G, CHARLOTTE, NC, 28226, US

(21) Appl. No.: 11/493,738

(22) Filed: Jul. 26, 2006

(51) Int. Cl. G09F 15/00

(52) U.S. Cl. 40/607.05

(57) ABSTRACT

A back sign for roads has a mount affixed to the ground that is adjacent to a road. A back sign device is affixed to the mount. The mount has a front face that is visible to oncoming traffic. The back sign device is located on a rear face visible to traffic that has passed the back sign. Whereby a driver can see the back sign device in a mirror mounted upon their vehicle after passing the back sign device and the back sign provides information to the driver.

### FIELD OF INVENTION

The instant application relates to back signs for roads.

### BACKGROUND OF THE INVENTION

Road signs are signs that are adjacent to a road that provide information to the drivers and passengers of vehicles traveling on the road. A road sign can give information about many things, including: the speed limit, mileage, road conditions, crossings, exit information, advertisements, etc.

Current road signs include a mount and a sign. The mount provides a foundation for the road sign and prevents the road sign from being moved out of position. The sign provides a surface for information to be printed on to be displayed to approaching vehicles. The sign is mounted on a face that is visible to oncoming traffic. As vehicles approach the road sign, the driver and/or passenger of a vehicle may see the sign and read the information printed on the sign.

One problem with current road signs is they are insufficient in providing all of the information necessary for the driver of a vehicle. For example, a truck driver can read a road sign that shows a gas station at a certain exit and take the exit thinking that the gas station is accessible to trucking rigs. The driver may exit off of the highway only to find out that the gas station is not accessible to trucking rigs. The truck driver then must find a place to turn around, get back on the highway, and proceed to look for another gas station, where the same situation may occur. This problem could be corrected by providing additional information to the driver of the truck about whether or not the gas station is accessible to trucking rigs. The information could be added to the front of the sign, but most signs are already full, and federal and state laws prevent certain signs from being any larger than they already are.

Accordingly, there is a need for back signs for roads that provide information to a driver.

### SUMMARY OF THE INVENTION

The instant invention is a back sign for a road. The back sign has a mount affixed to the ground that is adjacent to a road. A back sign device is affixed to the mount. The mount has a front face that is visible to oncoming traffic. The back sign device is located on a rear face visible to traffic that has passed the back sign device. Whereby, a driver can read the back sign device in a mirror mounted upon their vehicle after passing the back sign device.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIGS. 1a and 1b are isometric views of an embodiment of a back sign for roads.

FIG. 2 is an isometric view of the view through a mirror of the back sign for roads in FIG. 1b.

### DETAILED DESCRIPTION OF THE INVENTION

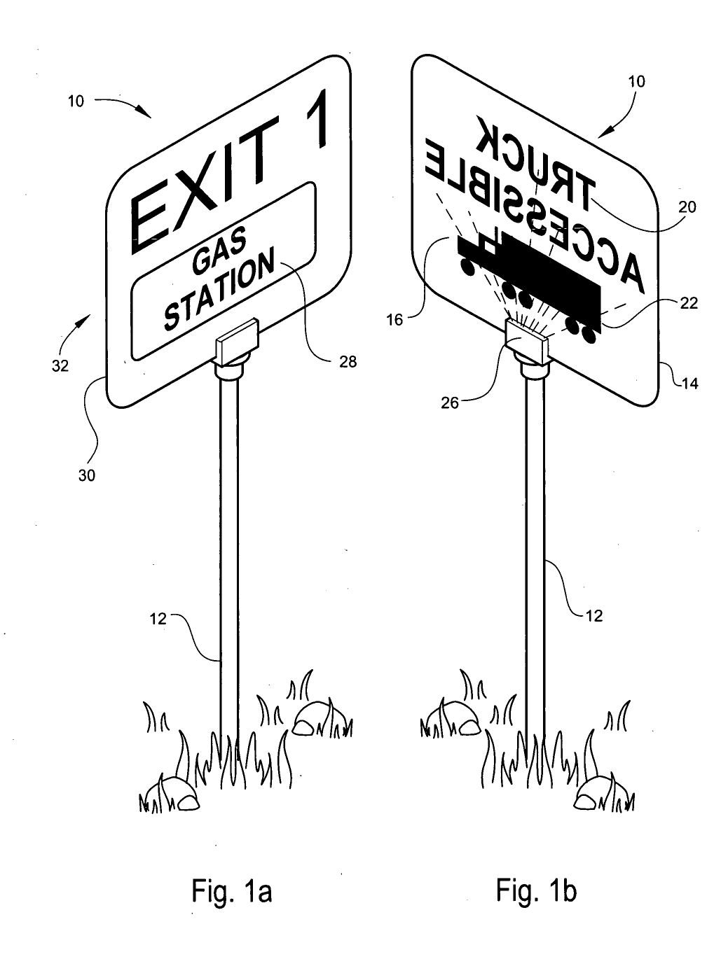

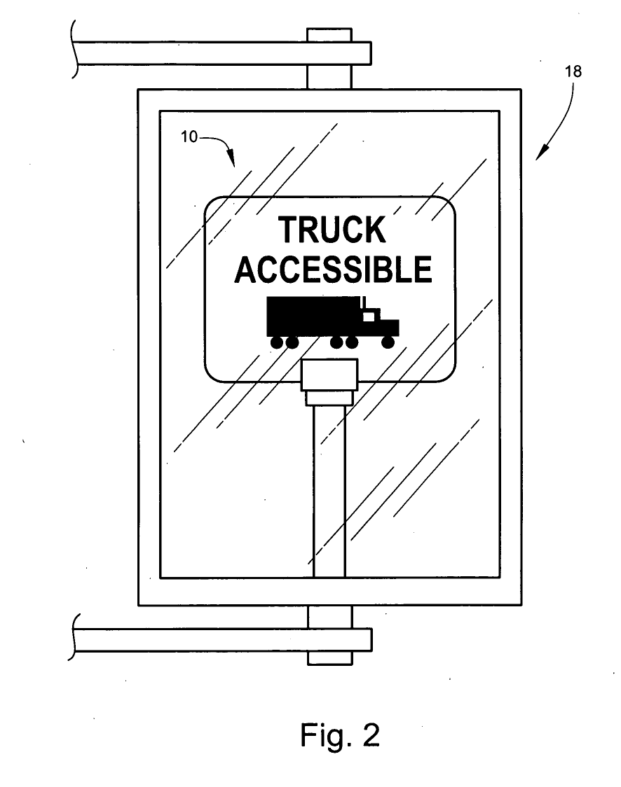

Referring to the drawings, wherein like numerals indicate like elements, there is shown in FIGS. 1a and 1b an embodiment of a back sign 10 for roads. Back sign 10 includes a mount 12 and a back sign device 14. Back sign 10 may be located adjacent a road. Back sign 10 may be for providing information to a driver. After the driver's vehicle has passed by back sign 10, the driver may see the information on back sign 10 by looking through a mirror 18 (see FIG. 2). Back sign 10 may be attached to a preexisting road information sign 32 or advertisement.

Mount 12 may be included in back sign 10 (see FIGS. 1a and 1b). Mount 12 may be for providing a support for back sign device 14. Mount 12 may be any structure that can support back sign device 14. Mount 12 may include, but is not limited to, a pole, beam, rod, platform, wall, etc. Mount 12 may be a preexisting road information sign 32 (see FIG. 1a) or advertisement, meaning, back sign device 14 may be attached to the back of the preexisting road information sign 32 or advertisement. Mount 12 may include a rear face 16. Mount 12 may also include a front face 28.

Back sign device 14 may be attached to mount 12 (see FIG. 1b). Back sign device 14 may be attached to mount 12 by a number of conventional means, including but not limited to, bolts, screws, latches, fasteners, joints, etc. Back sign device 14 may be for providing information to a driver. Back sign device 14 may be any device for providing information to a driver. Back sign device 14 may be located on rear face 16 of mount 12. Back sign device 14 may be viewed by a driver through mirror 18 after the driver's vehicle has passed back sign 10. Back sign device 14 may include any form of communication. This communication may include words/letters 20 that are written backwards. These words/letters 20 that are written backwards allow a driver to view them in mirror 18 so that the words/letters 20 appear normal. Back sign device 14 may include symbols/ colors 22. The symbols/colors 22 may be any symbol or color, including, but not limited to a symbol or color that is recognizable to have a certain meaning to drivers.

Rear face 16 may be apart of mount 12 (see FIG. 1b). Rear face 16 may be for providing a face for back sign device 14. Rear face 16 may be faced in any direction. Preferably, rear face 16 may be faced in the direction where back sign device 14 is most visible to a vehicle that has passed by back sign 10. Rear face 16 may be opposite of front face 28 or may be at any angle to front face 28.

Front sign device 30 may be attached to mount 12 (see FIG. 1a). Front sign device 30 may be attached to mount 12 by a number of conventional means, including but not limited to, bolts, screws, latches, fasteners, joints, etc. Front sign device 30 may be for providing information to a driver. Front sign device 30 may be any device for providing information to a driver, including but not limited to, a conventional sign or advertisement. Front sign device 30 may be located on front face 28 of mount 12. Front sign device 30 may be viewed by a driver or passengers of a vehicle that is approaching back sign 10. Front sign device 30 may include any form of communication, including, but not limited to, words, letters, symbols, colors, figures, etc.

Front face 28 may be apart of mount 12 (see FIG. 1a). Front face 28 may be for providing a face for front sign device 30. Front face 28 may be faced in any direction. Preferably, front face 28 may be faced in the direction where front sign device 30 may be most visible to oncoming traffic.

The mirror 18 of FIG. 2 may be any mirror. Mirror 18 may be a mirror mounted on or in a vehicle. Mirror 18 may be a standard side view mirror or a standard rearview mirror. Mirror 18 may be flat or convex and may be any shape or size.

A light 26 may be included in back sign 10 (see FIG. 1b). Light 26 may be for illuminating back sign device 14. Light 26 may be any light capable of illuminating back sign device 14.

In operation, back sign 10 would be positioned along a road, highway, interstate, etc. As vehicles approach back sign 10 the driver or passenger of a vehicle can read the communication on front sign device 30. After the vehicle passes by back sign 10, the driver may view back sign device 14 through mirror 18 (a side view or rear view) and obtain additional information about the communication on front sign device 30.

For example, a truck driver may approach back sign 10 and see on front sign device 30 that a gas station is available at the next exit. After the truck passes back sign 10, the truck driver may view back sign device 14 through mirror 18 and obtain information on whether or not the gas station is truck accessible (see FIG. 2).

As another example, a truck driver may approach back sign 10 and see on front sign device 30 that a gas station is available at the next exit. Because gas station names are constantly changing, often times, the problem of a known truck stop (like Pilot®) buying a non-accessible truck stop occurs (for example, Pilot® truck stops bought out Speedway® and not all Speedway® stations are truck accessible). After the truck passes back sign 10, the truck driver may view back sign device 14 through mirror 18 and obtain information (such as Pilot® written backwards) on whether or not the gas station is truck accessible.

The present invention may be embodied in other forms without departing from the spirit and the essential attributes thereof, and, accordingly, reference should be made to the appended claims, rather than to the foregoing specification, as indicated in the scope of the invention.

I claim:

1. A back sign for roads comprising:
a mount affixed to the ground and being adjacent a road, and having a front face visible to oncoming traffic;
a back sign device affixed to said mount and located on a rear face visible to traffic that has passed the back sign device;
whereby a driver can see said back sign device in a mirror after passing the back sign and said back sign device providing information to the driver.

2. The back sign for roads of claim 1 where said back sign device comprising words written backwards indicating information to the driver.

3. The back sign for roads of claim 1 where said back sign device comprising a symbol indicating information to the driver.

4. The back sign for roads of claim 1 where said back sign device comprising a color indicating information to the driver.

5. The back sign for roads of claim 1 further comprising a light for illuminating the back sign device.

6. The back sign for roads of claim 1 where said front face comprising a front sign device being visible to oncoming traffic.

7. The back sign for roads of claim 6 where said front sign device being a road information sign.

8. The back sign for roads of claim 6 where said front sign device being an advertisement.
